(19) United States
(12) Patent Application Publication
(10) Pub. No.: US 2024/0094381 A1
(43) Pub. Date: Mar. 21, 2024

(54) STATION ADAPTIVE RANGING

(71) Applicant: MAXLINEAR, INC., CARLSBAD, CA (US)

(72) Inventors: Rong Zhang, San Jose, CA (US); Kapil Gulati, Sunnyvale, CA (US); Hossein Dehghan-Fard, Diablo, CA (US)

(73) Assignee: MAXLINEAR, INC., CARLSBAD, CA (US)

(21) Appl. No.: 18/471,191

(22) Filed: Sep. 20, 2023

Related U.S. Application Data
(60) Provisional application No. 63/376,324, filed on Sep. 20, 2022.

(51) Int. Cl. G01S 13/76; H04W 64/00

(52) U.S. Cl. CPC G01S 13/767; H04W 64/00

(57) ABSTRACT

A responding station (STA) for adaptive ranging may comprise a transceiver configured to receive, from an initiating STA, a signal comprising one or more of a frame or a data packet, and a processing device. The processing device may be configured to: identify, at the responding STA, one or more of the frame or the data packet; identify, at the responding STA, one or more physical layer measurements based on the one or more of the frame or the data packet; identify, at the responding STA, one or more application layer requests comprising a ranging accuracy level; and determine, at the responding STA, one or more ranging parameters for a ranging operation based on the one or more physical layer measurements and the ranging accuracy level.

### RELATED APPLICATION

This application claims the benefit of U.S. Provisional Application No. 63/376,324, filed Sep. 20, 2022, the disclosure of which is incorporated herein by reference in its entirety.

The examples discussed in the present disclosure are related to station adaptive ranging, and in particular, to station adaptive ranging accuracy and network usage.

### BACKGROUND

Unless otherwise indicated herein, the materials described herein are not prior art to the claims in the present application and are not admitted to be prior art by inclusion in this section.

Wi-Fi® communications may be configured to occur in multiple frequency bands, including the 2.4 GHz, 5 GHz, 6 GHz, and 60 GHz frequency bands. Wi-Fi® communications may be used in various use cases which may include connecting laptops, printers, smartphones, and other devices. Wi-Fi® communications may also be used in vehicular communications.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A responding station (STA) for adaptive ranging may include a transceiver configured to receive, from an initiating STA, a signal comprising one or more of a frame or a data packet, and a processing device. The processing device may be configured to: identify, at the responding STA, one or more of the frame or the data packet; identify, at the responding STA, one or more physical layer measurements based on the one or more of the frame or the data packet; identify, at the responding STA, one or more application layer requests comprising a ranging accuracy level; and determine, at the responding STA, one or more ranging parameters for a ranging operation based on the one or more physical layer measurements and the ranging accuracy level.

An initiating station (STA) for adaptive ranging may include a processing device and a transceiver. The processing device may be configured to identify, at the initiating STA, one or more of a frame or a data packet based on one or more initial ranging parameters for a ranging operation; compute, at the initiating STA, one or more physical layer measurements based on the one or more of the frame or the data packet; identify, at the initiating STA, one or more application layer requests comprising a ranging accuracy level; and compute, at the initiating STA, one or more adjusted ranging parameters for the ranging operation based on the one or more physical layer measurements and the ranging accuracy level. The transceiver may be configured to transmit, from the initiating STA to responding STA, the one or more of the frame or the data packet based on the one or more adjusted ranging parameters.

A method for adaptive ranging may include: receiving a ranging accuracy level from an application layer of a first station (STA) in wireless communication with a second STA; receiving one or more physical layer measurements of the first STA; and computing one or more ranging parameters for a ranging operation based on the ranging accuracy level and the one or more physical layer measurements.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a timing diagram for adaptive ranging for a station (STA).

FIG. 2 illustrates an example negotiation and exchange between an initiating STA and a responding STA.

FIG. 3 illustrates an example of adaptive ranging for a STA.

FIG. 4 illustrates an example of adaptive ranging for an STA, including examples for two implementations.

FIG. 5 illustrates an example process flow of a responding station configured for adaptive ranging.

FIG. 6 illustrates an example process flow of an initiating station configured for adaptive ranging.

FIG. 7 illustrates an example process flow for adaptive ranging.

FIG. 8 illustrates an example communication system configured for adaptive ranging.

FIG. 9 illustrates a diagrammatic representation of a machine in the example form of a computing device within which a set of instructions, for causing the machine to perform any one or more of the methods discussed herein, may be executed.

FIG. 10A illustrates an example of variations in parameters that may be modified in the adaptive ranging for an STA.

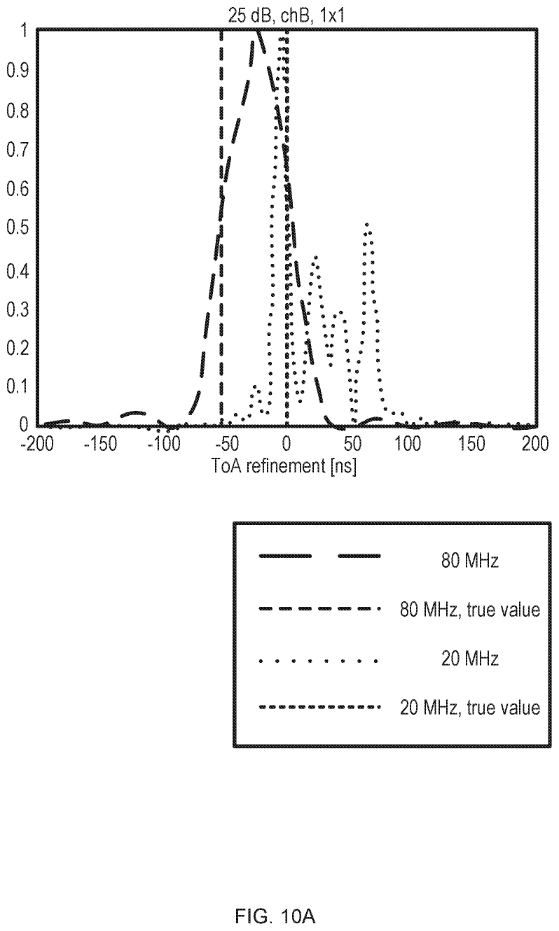

FIG. 10B illustrates an example of variations in parameters that may be modified in the adaptive ranging for an STA.

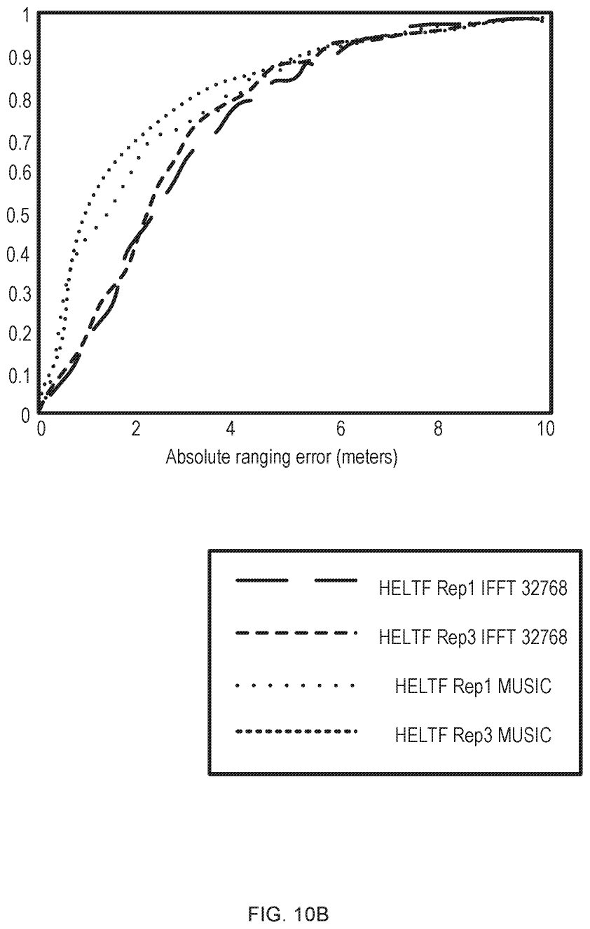

### DESCRIPTION OF EMBODIMENTS

Home, office, stadium, and outdoor networks, a.k.a. wireless local area networks (WLAN) may be established using a device called a Wireless Access Point (WAP). The WAP may include a router. The WAP may wirelessly couple the devices of the local network, e.g. wireless stations such as: computers, printers, televisions, digital video (DVD) players, security cameras, and smoke detectors to one another and to the Cable or Subscriber Line through which Internet, video, and television may be delivered to the local network. WAPs may implement the institute of electrical and electronics engineers (IEEE) 802.11 standard which may be a contention-based standard for handling communications among multiple competing devices for a shared wireless communication medium on a selected one of a plurality of communication channels. The frequency range of each communication channel may be specified in the corresponding one of the IEEE 802.11 protocols being implemented, e.g. “a”, “b”, “g”, “n”, “ac”, “ad”, “ax”, “ay”, “be”. Communications may follow a hub and spoke model with a WAP at the hub and the spokes corresponding to the wireless links to one or more ‘client’ devices or stations (STA) utilizing the WLAN.

Fine Time Measurement (FTM) may be used to estimate distance between two devices based on the propagation time of signal between the devices. In operation, use of FTM, including both 11mc and its enhancement 11az, may use various ranging parameters to be properly configured in order to successfully operate. Ranging parameters may be configured/reconfigured by exchanging FTM frames during the negotiation/modification stage and used during the measurement stage.

However, configuration of ranging parameters may be fixed, or may be configured and carried forward in a suboptimal way. Using such fixed configurations, or even carrying forward suboptimal configurations of ranging parameters may lead to inadequate ranging accuracy, inefficient medium utilization, and/or undesirable power consumption. For example, when there are too few FTM frames per burst, this may cause a noisy time of arrival (ToA), which may lead to inadequate accuracy in ranging information (e.g., a loss on the order of meters). As another example, when there are too many FTM frames per burst, there may be no increase in accuracy but a waste of airtime (e.g., a loss in response time based on decrease in available bandwidth on the order of milliseconds (ms)). Additionally, these negative impacts may be aggregated and amplified in complicated many-to-many FTM/ranging scenarios.

In some examples, to provide an optimal and timely FTM, the present disclosure provides a method for decision-based adaptive FTM control and parameters configuration. For example, a cross-layer approach may be implemented. An application layer may provide a level of accuracy which may be desired from the ranging process. The physical layer (PHY), such as the baseband (BB) and/or other firmware (FW) may receive an FTM frame and/or a null data packet (NDP) associated with ranging. Raw statistics may be observed and/or additional statistics may be generated by the PHY. An adaptive configuration determination may be performed (e.g., by a software program or other similar process operating on the STA) using the information from the application layer and the PHY. Measurements may be collected and the system may continue to be adapted to enhance accuracy (e.g., based on error distribution or accuracy deviation).

In some examples, the present disclosure may integrate with previous standards (such as IEEE 802.11mc and/or 802.11az) to facilitate adaptive ranging. Additionally, when multi-STA ranging is used, accuracy and/or decreased network usage may be amplified as more and more STAs are involved in the ranging. Additionally, many market segments may benefit from indoor location services, such as business venue enterprises, finance, retail, health care, and entertainment.

In one example, a responding station (STA) may be configured for adaptive ranging. The responding STA may include a transceiver configured to receive, from an initiating STA, a signal comprising one or more of a frame or a data packet, and a processing device. The processing device may be configured to: identify, at the responding STA, one or more of the frame or the data packet; identify, at the responding STA, one or more physical layer measurements based on the one or more of the frame or the data packet; identify, at the responding STA, one or more application layer requests comprising a ranging accuracy level; and determine, at the responding STA, one or more ranging parameters for a ranging operation based on the one or more physical layer measurements and the ranging accuracy level.

In another example, an initiating STA may be configured for adaptive ranging. The initiating STA may include a processing device and a transceiver. The processing device may be configured to identify, at the initiating STA, one or more of a frame or a data packet based on one or more initial ranging parameters for a ranging operation; compute, at the initiating STA, one or more physical layer measurements based on the one or more of the frame or the data packet; identify, at the initiating STA, one or more application layer requests comprising a ranging accuracy level; and compute, at the initiating STA, one or more adjusted ranging parameters for the ranging operation based on the one or more physical layer measurements and the ranging accuracy level. The transceiver may be configured to transmit, from the initiating STA to responding STA, the one or more of the frame or the data packet based on the one or more adjusted ranging parameters.

A method for adaptive ranging may include: receiving a ranging accuracy level from an application layer of a first station (STA) in wireless communication with a second STA; receiving one or more physical layer measurements of the first STA; and computing one or more ranging parameters for a ranging operation based on the ranging accuracy level and the one or more physical layer measurements.

Embodiments of the present disclosure will be explained with reference to the accompanying drawings.

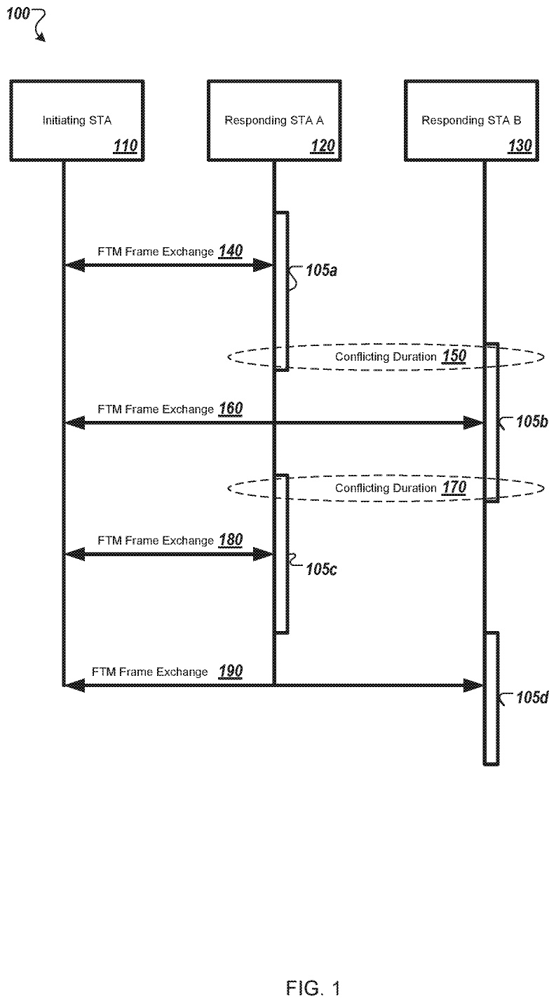

FIG. 1 illustrates a timing diagram 100 between an initiating STA 110, a responding STA A 120, and a responding STA B 130. A device (e.g., an initiating STA 110 or a responding STA such as responding STA A 120 or responding STA B 130) may comprise a processing device and a transceiver. The transceiver may be configured to receive one or more of frame or a data packet. The processing device (e.g., an initiating STA 110 or a responding STA such as responding STA A 120 or responding STA B 130) may be configured to identify one or more of the frame or the data packet from the transceiver.

The initiating STA (e.g., initiating STA 110) may be configured to perform an FTM frame exchange operation with a responding STA (e.g., responding STA A 120). The FTM frame exchange 140 operation may be performed when a burst duration 105a is active between the initiating STA (e.g., initiating STA 110) and the responding STA (e.g., responding STA A 120).

Alternatively or in addition, the initiating STA (e.g., initiating STA 110) may be configured to perform an FTM frame exchange 160 with a different responding STA (e.g., responding STA B 130). The FTM frame exchange 160 may be performed during a different burst duration 105b. Portions of the burst duration 105a and portions of the burst duration 105a may conflict, as shown by the conflicting duration 150.

Alternatively or in addition, the initiating STA (e.g., initiating STA 110) may be configured to perform one or more additional FTM frame exchanges with the responding STA (e.g., responding STA A 120). The one or more additional FTM frame exchanges (e.g., FTM frame exchange 180) may be performed during one or more additional burst durations (e.g., burst duration 105c).

Alternatively or in addition, the initiating STA (e.g., initiating STA 110) may be configured to perform one or more additional FTM frame exchanges with the different responding STA (e.g., responding STA B 130). The one or more additional FTM frame exchanges (e.g., FTM frame exchange 190) may be performed during one or more additional burst durations (e.g., burst duration 105d). The one or more additional burst durations (e.g., 105c) may conflict with one or more burst durations (e.g., 105b), as shown by conflicting duration 170, and may not conflict with one or more additional burst durations (e.g., 105d).

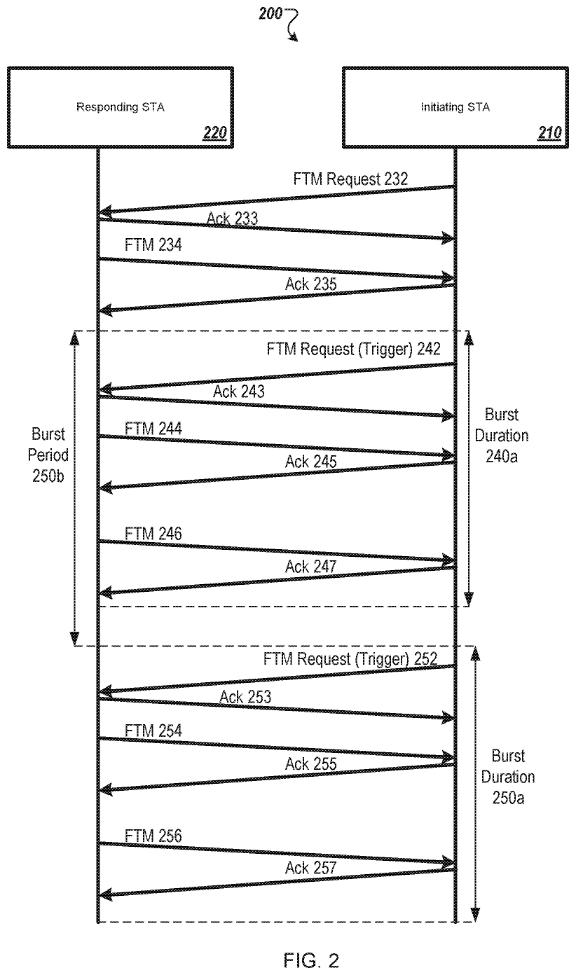

As illustrated in the timing diagram 200 in FIG. 2, a responding STA (e.g., responding STA 220) may be configured to communicate with an initiating STA (e.g., initiating STA 210) for adaptive ranging. The initiating STA 210 may be configured to send an FTM request 232 to the responding STA 220, and may receive an acknowledgement (ack) 233 from the responding STA 220 to acknowledge receipt of the FTM request 232. The responding STA may be configured to send an FTM 234 to the initiating STA 210 and may receive an ack 235 from the initiating STA 210 to acknowledge receipt of the FTM 234.

The communication of FTM requests (e.g., FTM requests 232, FTM Request (Trigger) 242, 252), FTM (e.g., FTM 234, 244, 246, 254, 256), and acks (e.g., acks 233, 235, 243, 245, 247, 253, 255, 257) between the initiating STA and the responding STA 220 may continue for one or more iterations. The burst duration may be the duration during which one or more FTM requests, FTM, and acks may occur, as shown by burst duration 240a and burst duration 250a. The burst period may be the period between bursts as shown by burst period 250b.

A station (STA) (e.g., an initiating STA or a responding STA) may be configured for adaptive ranging. The STA may comprise a transceiver and a processing device. The processing device may be configured to identify (e.g., at a responding STA from an initiating STA) one or more of a frame or a data packet (e.g., as illustrated in FIGS. 1 and 2). The processing device may be configured to identify (e.g., at the responding STA) one or more physical layer measurements based on the one or more of the frame or the data packet. The processing device (e.g., at the responding STA) may be configured to identify one or more application layer requests comprising a ranging accuracy level. The processing device (e.g., at the responding STA) may be configured to determine one or more ranging parameters for a ranging operation based on the one or more physical layer measurements and the ranging accuracy level.

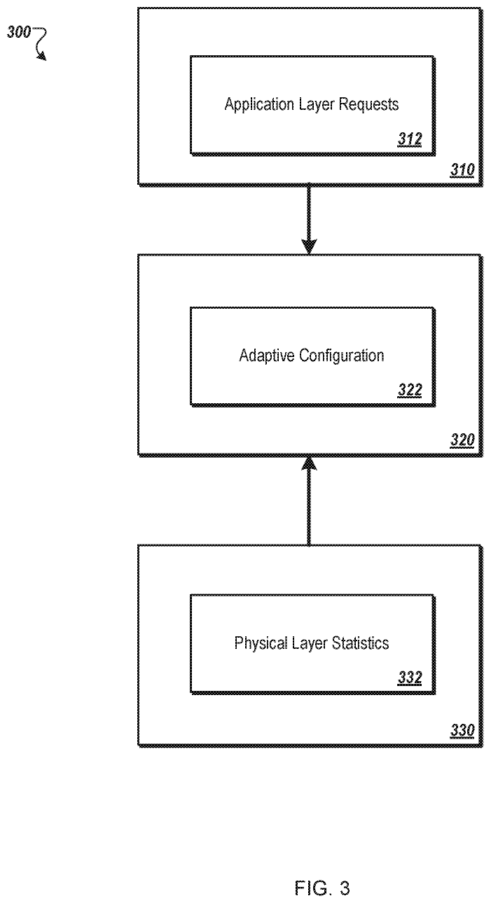

FIG. 3 illustrates functionality 300 of adaptive ranging for an STA. The one or more physical layer measurements may be physical layer statistics 332 which may be sent from a physical layer 330 (e.g., which may be implemented using a base-band processing device or firmware) to an adaptive configuration 322 operation (e.g., which may be implemented using software 320). Application layer requests 312 (which may be implemented using an application layer 310) may provide input to the adaptive configuration 322 operation.

As shown in Table 1, the physical layer statistics 332 may be based on one or more of: (i) a line of sight (LoS) level, (ii) a dispersion level, (iii) a mobility level, or (iv) a proximity level. For a LoS level, associated statistics from the PHY layer (e.g., physical layer statistics 332) may include a first path and/or a mean channel delay, or the like. For a dispersion level, associated statistics from the PHY layer (e.g., physical layer statistics 332) may include tap estimates, delay estimates, or the like. For a mobility level, associated statistics from the PHY layer (e.g., physical layer statistics 332) may include Doppler estimates, or the like. For a proximity level, associated statistics from the PHY layer (e.g., physical layer statistics 332) may include one or more of a received signal strength indication (RSSI), an error vector magnitude (EVM) quality, or the like.

TABLE 1
Physical Layer Statistics for Different Configurations

| | PHY | | |
|---|---|---|---|
| Decision Metric | Statistics | Parameter Config (11mc) | Parameter Config (11az) |
| LoS Level | First path | Number of bursts, burst | Rep, number of spatial |
| | Mean | duration, minimum delta | streams (N_STS), Tx |
| | channel | FTM, As soon as | power, NDP Tx power, |
| | delay | Possible (ASAP), FTMs | NDP target RSSI, UL |
| Dispersion Level | Tap | per burst, burst period, | target RSSI, immediate |
| | estimates | format and bandwidth, | feedback, min-max time |
| | Delay | burst period | between measures, |
| | estimates | | availability measures, |
| Mobility Level | Doppler | | availability window |
| | estimates | | |
| Proximity Level | RSSI | | |
| | Error Vector | | |
| | Magnitude | | |
| | (EVM) | | |

Physical layer statistics 332 may be measured at the physical layer 330 and sent to the adaptive configuration 322 operation which may be implemented using software. The physical layer statistics 332 may be measured using one or more of a baseband processing device or firmware. For example, the baseband processing device may measure the channel state information (CSI) and the firmware may determine that the underlying channel has a strong LoS. The CSI may be one or more of instantaneous CSI (e.g., for a slow-fading environment), statistical CSI (e.g., for a fast-fading environment), or a combination thereof (e.g., for a mixed-fading environment). Statistical CSI may comprise one or more of a fading distribution, an average channel gain, a LoS, a spatial correlation, or the like. The CSI may be estimated using any suitable technique including one or more of least-square estimation, minimum mean square error estimation, neural network estimation, or the like.

The adaptive configuration 322 operation (e.g., implemented using software), in response to receiving the physical layer statistics 332 from the physical layer 330, may compute the one or more ranging parameters to use fewer FTM frames and/or ranging NDPs. For example, when the statistical CSI has a value that indicates a strong LoS, the adaptive configuration 322 operation may determine that network resource usage may be reduced without degrading the LoS below a selected threshold (e.g., which may be provided by the application layer 310 using an application layer request 312). The adaptive configuration 322 operation may be configured to: (i) cause the use of fewer FTM frames to reduce network resource usage, (ii) cause the use of fewer ranging NDPs to reduced network resource usage.

Alternatively or in addition, when the statistical CSI has a value that indicates a weak LoS, the adaptive configuration 322 operation may determine that the network resource usage may be increased to increase the LoS above a selected threshold (e.g., which may be provided by the application layer 310 using an application layer request 312). That is, the adaptive configuration 322 operation may be configured to: (i) cause the use of more FTM frames (which may increase network resource usage) and may increase the LoS above the selected threshold, and/or (ii) cause the use of more ranging NDPs (which may increase network resource usage) and may increase the LoS above the selected threshold.

In one example, the baseband processing device may measure the channel state information (CSI) and the firmware may determine that the underlying channel has a large channel width. The adaptive configuration 322 operation (e.g., implemented using software), in response to receiving the physical layer statistics 332 from the physical layer 330, may compute the one or more ranging parameters to use one or more of a larger number of FTM frames or an increased number of spatial streams (N_STS).

Alternatively or in addition, the baseband processing device may measure the channel state information (CSI) and the firmware may determine that the underlying channel has a small channel width. The adaptive configuration 322 operation (e.g., implemented using software), in response to receiving the physical layer statistics 332 from the physical layer 330, may compute the one or more ranging parameters to use one or more of a smaller number of FTM frames or a smaller N_STS to reduce network usage.

In another example, the baseband processing device may measure the channel state information (CSI) in a plurality of frames (e.g., consecutive frames) and the firmware may determine that the underlying channel has fast time variations. The adaptive configuration 322 operation (e.g., implemented using software), in response to receiving the physical layer statistics 332 from the physical layer 330, may compute the one or more ranging parameters to use one or more of a smaller minimum change in FTM, or a smaller availability window.

Alternatively or in addition, the baseband processing device may measure the channel state information (CSI) in a plurality of frames (e.g., consecutive frames) and the firmware may determine that the underlying channel has slow time variations. The adaptive configuration 322 operation (e.g., implemented using software), in response to receiving the physical layer statistics 332 from the physical layer 330, may compute the one or more ranging parameters to use one or more of a larger change in FTM, or a larger availability window. Using a larger change in FTM or a large availability window may decrease network usage without degrading the ranging accuracy level value below a ranging accuracy level (e.g., which may be received as an application layer request 312 from the application layer 310).

In another example, the baseband processing device may measure RSSI and the firmware may determine that the underlying channel is operating in a low signal region. The signal region may be measured using one or more of: a signal to noise ratio (SNR), a signal to noise plus interference ratio (SINR), or the like. The adaptive configuration 322 operation (e.g., implemented using software), in response to receiving the physical layer statistics 332 from the physical layer 330, may compute the one or more ranging parameters to use one or more of a larger number of FTM frames or an increase number of long training field repetitions (e.g., high efficiency long training field (HELTF) repetitions).

Alternatively or in addition, when the baseband processing device measures the RSSI and the firmware determines that the underlying channel is operating in a high signal region, adaptive configuration 322 operation (e.g., implemented using software) may compute the one or more ranging parameters to use one or more of a smaller number of FTM frames or a decreased number of long training field repetitions (e.g., high efficiency long training field (HELTF) repetitions). A smaller number of FTM frames and/or a decreased number of long training field repetitions may decrease network usage without degrading the signal below a selected signal threshold (e.g., which may be received as an application layer request 312 from the application layer 310).

The adaptive configuration 322 operation may be configured to optimize the one or more ranging parameters based on one or more of the application layer requests 312 (e.g., which may include a ranging accuracy level, a signal threshold, or the like) or network usage amount to perform the ranging operation. The adaptive configuration 322 operation may be configured to compute initial ranging parameters and/or compute adjusted ranging parameters to balance the use of networking resources for the ranging operation and the ranging accuracy level. In some examples, the adaptive configuration 322 operation may use a feedback loop and/or a closed loop system to balance the use of networking resources for the ranging operation and the ranging accuracy level.

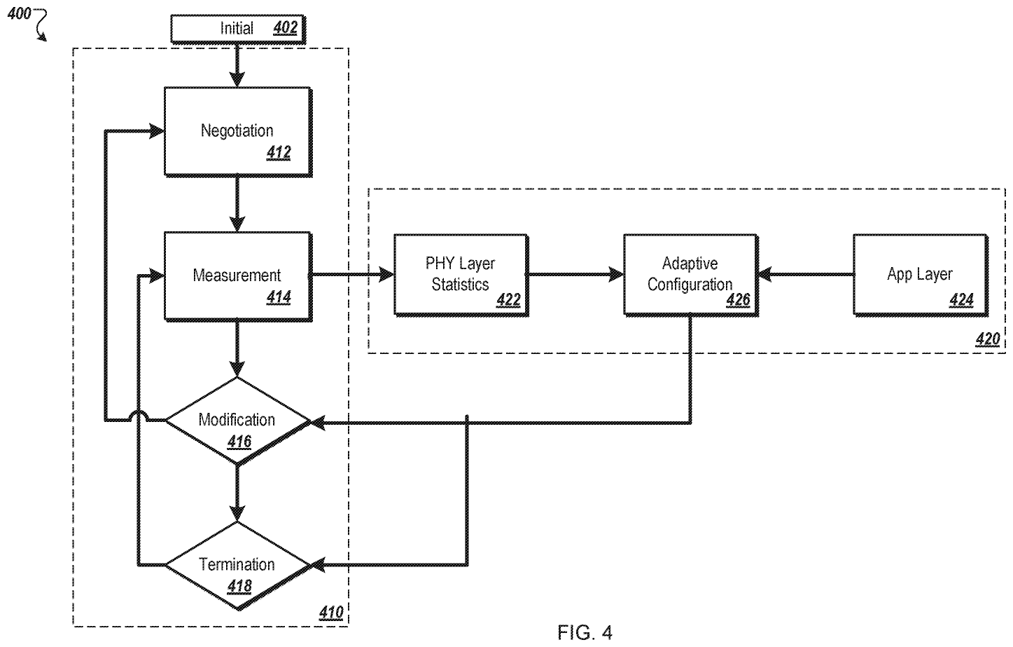

FIG. 4 illustrates an example block diagram 400 of adaptive ranging for a station (STA). FIG. 4 shows a high-level view of a ranging process 410 (e.g., an FTM process) and an adaptive process 420 that may be integrated with the ranging process 410.

When initialization has occurred (e.g., initial 402), an initiating STA and a receiving STA may undergo negotiation 412 (e.g., handshakes and/or other negotiations when beginning communications between devices). After the negotiation 412, measurements may be collected. For example, an initiating station (ISTA) may send one or more of an FTM frame or an NDP to a responding station (RSTA).

Based on the communicated frame(s) (e.g., an FTM frame) or signal(s) (e.g., NDP), one or more measurements 414 may be collected. The one or more measurements 414 may comprise one or more physical layer measurements (e.g., physical layer statistics 422) which may comprise one or more of: CSI, RSSI, EVM, a first path, a mean channel delay, a tap estimate, a delay estimate, a power delay profile (PDP), a Doppler estimate, or other suitable measurements, and/or other statistics based on measurements.

When the measurement 414 operation has occurred and/or when physical layer statistics 422 have been computed, a processing device may be configured to determine when a modification 416 has occurred. The processing device may be configured to update the one or more ranging parameters when the modification 416 has occurred. The processing device may be configured to terminate (e.g., termination 418) the ranging operation when the modification 416 has not occurred.

Modification 416 may occur when one or more of: (i) when one or more of a first initiating STA or a first receiving STA is communicating with a new device (e.g., a second initiating STA or a second receiving STA that may not have been in communication with the first initiating STA or first receiving STA), (ii) when one or more of the first initiating STA or the first receiving STA has lost a previous connection (e.g., with a second initiating STA or a second receiving STA) and formed another connection (e.g., with a third initiating STA or a third receiving STA), (iii) when one or more of the first initiating STA or the first receiving STA has received updated ranging parameters, or (iv) the like. When modification 416 has occurred, the process flow may return to the negotiation 412 operation.

The modification 416 may include changing one or more parameters associated with the ranging operations (e.g., one or more ranging parameters). In these and related circumstances, when changes to the one or more ranging parameters have occurred, the same two STAs (e.g., the initiating STA and the associated responding STA) may renegotiate (e.g., in a negotiation 412 operation) to update those parameters (e.g., using a measurement 414 operation, and/or an adaptive process 420, and/or a modification 416 operation) for one or more additional rounds of ranging with increased accuracy and/or with preserved bandwidth and/or network resources.

If modification 416 has not occurred, a processing device may be configured to determine when the process is to be terminated (e.g., using termination 418 operation). The processing device may be configured to: determine that a process is not to be terminated (e.g., using termination 418 operation), and that further measurement 414 may be collected and/or an adaptive process 420 may be performed.

An adaptive process 420 may be used for adaptive ranging for a station (STA). An application layer 424 of the station (e.g., an initiating STA or a responding STA) may determine a ranging accuracy level that may be used e.g., to increase the accuracy of adaptive ranging and to decrease the usage of network resources. The ranging accuracy level may be one or more of: (i) a gradation level (e.g., a high level of accuracy, a medium level of accuracy, or a low level of accuracy), (ii) a numerical value (e.g., accuracy within one or more of thirty meters, accuracy within twenty meters, accuracy within ten meters, accuracy within eight meters, accuracy within five meters, accuracy within three meters, or the like), (iii) a ratio (e.g., accuracy within a selected distance in meters divided by the total distance between an initiating STA and a responding STA), (iv) an average value (e.g., an average accuracy within a selected distance), a variability (e.g., a variance, standard deviation, or the like for values), or any other suitable metric providing suitable information about a ranging accuracy level.

Measurements 414 and/or physical layer statistics 422 that may be obtained in the ranging process (e.g., whether raw measurements or statistical variations thereof) may be provided from the PHY layer to the adaptive configuration 426 block. Example physical layer statistics are shown in Table 2.

TABLE 2
Physical Layer Statistics

| Decision Metric | PHY Statistics |
|---|---|
| LoS Level | First path |
| | Mean channel delay |
| Dispersion Level | Tap estimates |
| | Delay estimates |
| Mobility Level | Doppler estimates |
| Proximity Level | RSSI |
| | EVM |

Using the data obtained from the PHY (e.g., measurements 414 and/or physical layer statistics 422) and the ranging accuracy level from the application layer 424, the adaptive configuration 426 operation may determine one or more ranging parameters for a ranging operation facilitate a ranging accuracy level within a network resource usage constraint (e.g., bandwidth usage constraint).

A processing device may be configured to compute updated ranging parameters using additional physical layer measurements (e.g., additional measurements 414 and/or additional physical layer statistics 422) that may be received in one or more iterations using a feedback loop (e.g., a feedback loop comprising a modification 416 operation, a negotiation 412 operation, a measurement 414 operation, an adaptive process 420, and so forth). The one or more ranging parameters may be fed back into the ranging process 410 in the modification 416 operation. Additionally or alternatively, the application layer 424 (e.g., which may be used to provide a ranging accuracy level) may be used to provide the termination 418 conditions of the ranging process 410 (e.g., when the ranging information is obtained, when a ranging accuracy level is achieved, when a network usage constraint is satisfied, or the like).

The adaptive configuration 426 operation may facilitate a feedback loop process (e.g., which may comprise a modification 416 operation, a negotiation 412 operation, a measurement 414 operation, an adaptive process 420, and so forth) which may be iteratively followed until a ranging accuracy level is satisfied. Additionally or alternatively, (i) measurements 414 may be collected using one or more initially estimated ranging parameters and/or one or more default ranging parameters, and (ii) one or more adjusted ranging parameters may be used to collect additional measurements in a second iteration (which may be repeated in the loop one or more times). Limits may be imposed on the number of times the feedback loop may be used for a given circumstance (e.g., one time looping past the one or more initially estimated and/or default ranging parameters, two times, three times, five times, ten times, or the like) to reduce network resource usage (e.g., bandwidth usage).

The adaptive configuration 426 process may be configured to determine one or more ranging parameters for a ranging operation. The one or more ranging parameters may comprise one or more of: a number of bursts, a burst duration, a minimum change in FTM, a priority level (e.g., as soon as possible (ASAP) priority), a number of FTM frames per burst, a burst period, a format, a bandwidth a number of repetitions (Rep), an N_STS, a transmission power, a null data packet transmission power, a null data packet RSSI target, an uplink (UL) RSSI target, an immediate feedback activity, a minimum measurement time, a maximum measurement time, an availability window, or the like.

The one or more ranging parameters may vary based on different ranging protocols or processes. For example, under IEEE 802.11mc, the one or more ranging parameters may include one or more of: a number of bursts, a burst duration, a minimum change in FTM, a priority level (e.g., ASAP priority), a number of FTM frames per burst, a burst period, a format, or a bandwidth. As another example, under IEEE 802.11az, the one or more ranging parameters may include one or more of: a number of Rep, an N_STS, a transmission power, an NDP transmission power, an NDP RSSI target, a UL RSSI target, immediate feedback activity, a minimum measurement time, a maximum measurement time, an availability window, or the like.

The adaptive configuration 426 operation may be configured for one or more of: a one-to-one ranging operation, a one-to-many ranging operation, or a many-to-many ranging operation. The one-to-one ranging process may be used when an ISTA communicates with an RSTA. The one-to-many ranging process may be operable when an ISTA communicates with a plurality of RSTAs. The many-to-many ranging process may be used when a plurality of ISTAs communicate with a plurality of RSTAs.

The ranging operation may be one or more of trigger based or non-trigger based. That is, the adaptive configuration 426 operation may be configured for FTM and/or other ranging processes that may be trigger based (TB), non-TB, or secure variations thereof.

The adaptive configuration 426 operation may be operable for the RSTA, e.g., by adjusting and/or modifying the one or more ranging parameters with one or more successive FTMs or other ranging processes which may be initiated by the ISTA. The adaptive configuration 426 operation may be operable for the ISTA, e.g., by adjusting and/or modifying the one or more ranging parameters and continuing to initiate FTM or other ranging processes. In one example, a processing device may be configured to identify (e.g., at the initiating STA) one or more of a frame or a data packet based on one or more initial ranging parameters for a ranging operation. The processing device may be configured to compute (e.g., at the initiating STA) one or more physical layer measurements based on the one or more of the frame or the data packet. The processing device may be configured to identify (e.g., at the initiating STA) one or more application layer requests comprising a ranging accuracy level. The processing device may be configured to compute (e.g., at the ISTA) one or more adjusted ranging parameters for the ranging operation based on the one or more physical layer measurements and the ranging accuracy level. A transceiver may be configured to transmit (e.g., from the ISTA to RSTA) the one or more of the frame or the data packet based on the one or more adjusted ranging parameters.

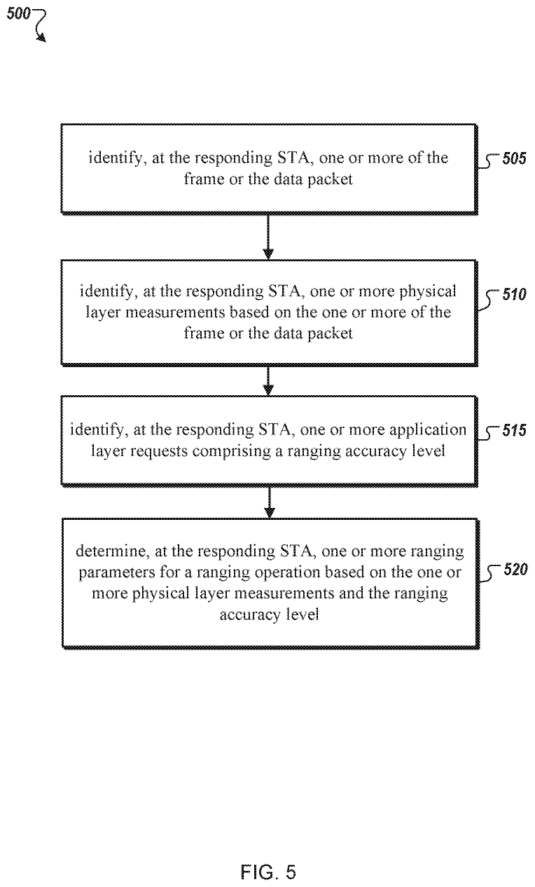

FIG. 5 illustrates a process flow of an example method 500 of adaptive ranging, in accordance with at least one example described in the present disclosure. The method 500 may be arranged in accordance with at least one example described in the present disclosure.

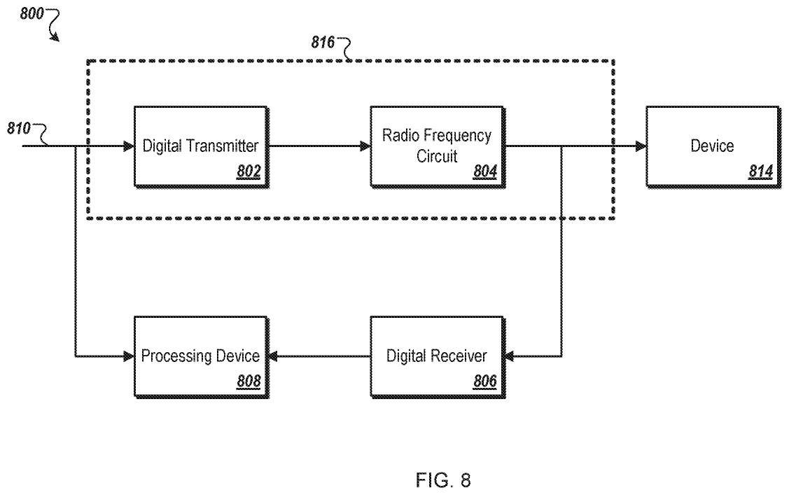

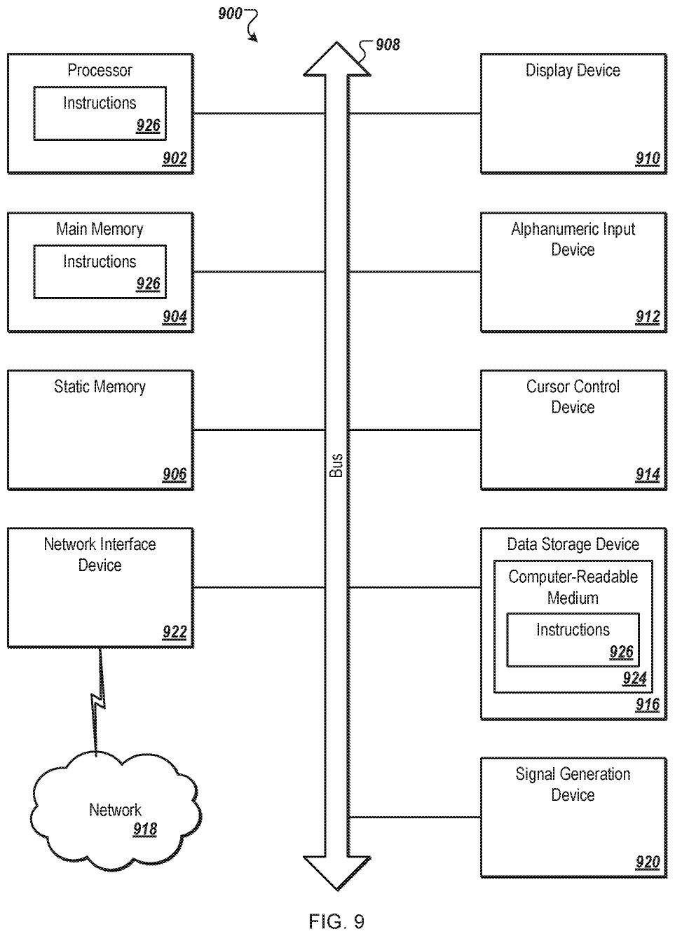

The method 500 may be performed by processing logic that may include hardware (circuitry, dedicated logic, etc.), software (such as is run on a computer system or a dedicated machine), or a combination of both, which processing logic may be included in the processing device (e.g., processor) 902 of FIG. 9, the communication system 800 of FIG. 8, or another device, combination of devices, or systems.

The method 500 may begin at block 505 where the processing logic may identify, at the responding STA, one or more of the frame or the data packet.

At block 510, the processing logic may identify, at the responding STA, one or more physical layer measurements based on the one or more of the frame or the data packet.

At block 515, the processing logic may identify, at the responding STA, one or more application layer requests comprising a ranging accuracy level.

At block 520, the processing logic may determine, at the responding STA, one or more ranging parameters for a ranging operation based on the one or more physical layer measurements and the ranging accuracy level.

Modifications, additions, or omissions may be made to the method 500 without departing from the scope of the present disclosure. For example, in some examples, the method 500 may include any number of other components that may not be explicitly illustrated or described.

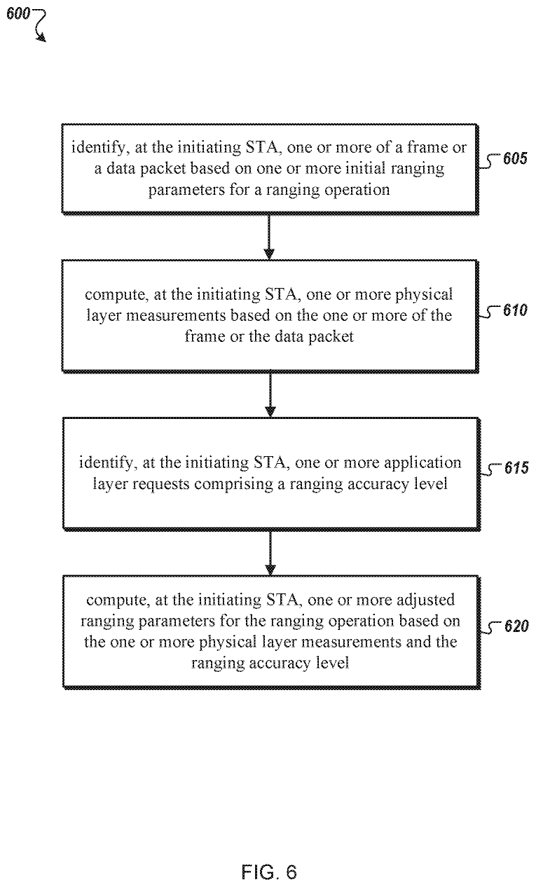

FIG. 6 illustrates a process flow of an example method 600 that may be used for adaptive ranging, in accordance with at least one example described in the present disclosure. The method 600 may be arranged in accordance with at least one example described in the present disclosure.

The method 600 may be performed by processing logic that may include hardware (circuitry, dedicated logic, etc.), software (such as is run on a computer system or a dedicated machine), or a combination of both, which processing logic may be included in the processing device (e.g., processor) 902 of FIG. 9, the communication system 800 of FIG. 8, or another device, combination of devices, or systems.

The method 600 may begin at block 605 where the processing logic may identify, at the initiating STA, one or more of a frame or a data packet based on one or more initial ranging parameters for a ranging operation.

At block 610, the processing logic may compute, at the initiating STA, one or more physical layer measurements based on the one or more of the frame or the data packet.

At block 615, the processing logic may identify, at the initiating STA, one or more application layer requests comprising a ranging accuracy level.

At block 620, the processing logic may compute, at the initiating STA, one or more adjusted ranging parameters for the ranging operation based on the one or more physical layer measurements and the ranging accuracy level.

Modifications, additions, or omissions may be made to the method 600 without departing from the scope of the present disclosure. For example, in some examples, the method 600 may include any number of other components that may not be explicitly illustrated or described.

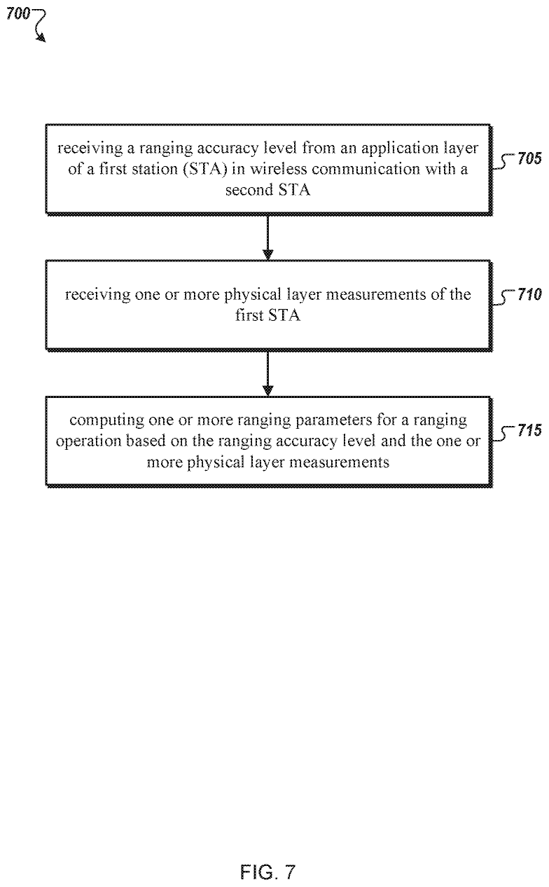

FIG. 7 illustrates a process flow of an example method 700 that may be used for adaptive ranging, in accordance with at least one example described in the present disclosure. The method 700 may be arranged in accordance with at least one example described in the present disclosure.

The method 700 may be performed by processing logic that may include hardware (circuitry, dedicated logic, etc.), software (such as is run on a computer system or a dedicated machine), or a combination of both, which processing logic may be included in the processing device (e.g., processor) 902 of FIG. 9, the communication system 800 of FIG. 8, or another device, combination of devices, or systems.

The method 700 may begin at block 705 where the processing logic may comprise receiving a ranging accuracy level from an application layer of a first station (STA) in wireless communication with a second station (STA).

At block 710, the processing logic may comprise receiving one or more physical layer measurements of the first station

At block 715, the processing logic may comprise computing one or more ranging parameters for a ranging operation based on the ranging accuracy level and the one or more physical layer measurements.

The method 700 may further comprise receiving one or more of a frame or a data packet from an application layer of the first STA. The method 700 may further comprise determining the one or more adjusted ranging parameters based on network resource usage. The method 700 may further comprise computing updated ranging parameters using additional physical layer measurements received in one or more iterations using a feedback loop. The method 700 may further comprise: determining when a modification has occurred; updating the one or more ranging parameters when the modification has occurred; and terminating the ranging operation when the modification has not occurred.

Modifications, additions, or omissions may be made to the method 700 without departing from the scope of the present disclosure. For example, in some examples, the method 700 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 8 illustrates a block diagram of an example communication system 800 configured for adaptive ranging, in accordance with at least one example described in the present disclosure. The communication system 800 may include a digital transmitter 802, a radio frequency circuit 804, a device 814, a digital receiver 806, and a processing device 808. The digital transmitter 802 and the processing device may be configured to receive a baseband signal via connection 810. A transceiver 816 may comprise the digital transmitter 802 and the radio frequency circuit 804.

In some examples, the communication system 800 may include a system of devices that may be configured to communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may be configured to communicate via one or more wireless connections. For example, the communication system 800 may include one or more devices configured to transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may be configured to obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may be configured to obtain a baseband signal. For example, as described herein, the transceiver 816 may be configured to generate a baseband signal and/or receive a baseband signal from another device. In some examples, the transceiver 816 may be configured to transmit the baseband signal. For example, upon obtaining the baseband signal, the transceiver 816 may be configured to transmit the baseband signal to a separate device, such as the device 814. Alternatively, or additionally, the transceiver 816 may be configured to modify, condition, and/or transform the baseband signal in advance of transmitting the baseband signal. For example, the transceiver 816 may include a quadrature up-converter and/or a digital to analog converter (DAC) that may be configured to modify the baseband signal. Alternatively, or additionally, the transceiver 816 may include a direct radio frequency (RF) sampling converter that may be configured to modify the baseband signal.

In some examples, the digital transmitter 802 may be configured to obtain a baseband signal via connection 810. In some examples, the digital transmitter 802 may be configured to up-convert the baseband signal. For example, the digital transmitter 802 may include a quadrature up-converter to apply to the baseband signal. In some examples, the digital transmitter 802 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a power amplifier (PA), a digital transmitter (e.g., 802), a digital front end, an IEEE 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may be configured to obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may be configured to generate a baseband signal for transmission. In these and other examples, the transceiver 816 may be configured to transmit the baseband signal to another device, such as the device 814.

In some examples, the device 814 may be configured to receive a transmission from the transceiver 816. For example, the transceiver 816 may be configured to transmit a baseband signal to the device 814.

In some examples, the radio frequency circuit 804 may be configured to transmit the digital signal received from the digital transmitter 802. In some examples, the radio frequency circuit 804 may be configured to transmit the digital signal to the device 814 and/or the digital receiver 806. In some examples, the digital receiver 806 may be configured to receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may be configured to communicate with additional devices and/or systems remote from the processing device 808, such as the transceiver 816 and/or the device 814. For example, the processing device 808 may be configured to send and/or receive transmissions from the transceiver 816 and/or the device 814. In some examples, the processing device 808 may be combined with other elements of the communication system 800.

Some portions of the detailed description are presented in terms of algorithms and symbolic representations of operations within a computer. An algorithm may be a series of configured operations leading to a desired end state or result. In example implementations, the operations carried out may use physical manipulations of tangible quantities for achieving a tangible result.

Description using terms such as detecting, determining, analyzing, identifying, scanning or the like, may include the actions and processes of a computer system or other information processing device that may manipulate and/or transform data represented as physical (electronic) quantities within the computer system's registers and memories into other data similarly represented as physical quantities within the computer system's memories or registers or other information storage, transmission, or display devices.

Example implementations may also relate to an apparatus for performing the operations herein. This apparatus may be specially constructed for the operations provided herein, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

An example apparatus may include a Wireless Access Point (WAP) and/or a station (STA), which may use a very large scale integration (VLSI) processor and/or program code. An example transceiver may couple via an integral modem to one or more of a cable, fiber, or digital subscriber backbone connection to the Internet to support wireless communications, e.g. IEEE 802.11 compliant communications, on a Wireless Local Area Network (WLAN). The WiFi® stage may include one or more of a baseband stage, an analog front end (AFE) stage, or an RF stage. In the baseband portion, wireless communications may be transmitted to and/or received from the one or more users/clients/stations to be processed. The AFE and RF portion may be configured to up-convert signals directed to one or more transmit paths of wireless transmissions (e.g., as initiated in the baseband). The RF portion may be configured to down-convert the signals received on the receive paths and pass them for further processing to the baseband.

An example apparatus may be a multiple-input multiple-output (MIMO) apparatus which may support as many as N×N discrete communication streams over N antennas. The signal processing units of the MIMO apparatus may be implemented as N×N. The value of N may be 4, 6, 8, 12, 16, or so forth. Extended MIMO operation may facilitate the use of up to 2N antennae in communication with a different wireless system. Extended MIMO systems may be configured to communicate with other wireless systems when the systems do not have the same number of antennae (e.g., some of the antennae of one of the stations may not be used).

Channel State Information (CSI) may be extracted independently of changes related to channel state parameters and may be used for spatial diagnosis services of the network such as motion detection, proximity detection, and/or localization which may be used in, for example, WLAN diagnosis, home security, health care monitoring, smart home utility control, elder care, automotive tracking and monitoring, home or mobile entertainment, automotive infotainment, or the like.

FIG. 9 illustrates a diagrammatic representation of a machine in the example form of a computing device 900 within which a set of instructions, for causing the machine to perform any one or more of the methods discussed herein, may be executed. The computing system may be configured to implement or direct one or more operations associated with latency-based contention. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device (e.g., a processor 902), a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate via a bus 908.

Processing device (e.g., processor 902) represents one or more general-purpose processing devices such as a microprocessor, central processing unit, or the like. More particularly, the processing device (e.g., processor 902) may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device (processor 902) may also include one or more special-purpose processing devices such as an application specific integrated circuit (ASIC), a field programmable gate array (FPGA), a digital signal processor (DSP), network processor, or the like. The processing device (e.g., processor 902) is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device (e.g., processor 902) during execution thereof by the computing device 900, the main memory 904 and the processing device (e.g., processor 902) also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

### EXAMPLES

The following provide examples according to the present disclosure.

### Example 1

FIGS. 12A and 12B illustrate examples of variations in ranging parameters that may be modified using adaptive ranging for an STA (e.g., an ISTA or an RSTA).

FIG. 12A is an example of PDP reconstruction showing the true value (e.g., an 80 MHz true value which may be positioned at an x value of 0 and a 20 MHz true value which may be positioned at an x value of −50) and the time of arrival (ToA) in nanoseconds (ns) for the packets (e.g., 80 MHz and 20 MHz) on the x-axis against a y-axis showing a normalized number of packets, as indicated by the legend in FIG. 12A. For example, there were additional peaks (e.g., increased number of packets) for the 80 MHz communication (e.g., peaks at x values of about −5, 20, 45, 65) when compared to the 20 MHz communication (a peak at about −25). As such, different responses having varying accuracies may occur in ranging when communicating using the 20 MHz band when compared to the 80 MHz band.

FIG. 12B is an example of the absolute ranging error in meters (i.e., shown on the x-axis) against a normalized number of data packets (i.e., shown on the y-axis) when the HELTF was varied in numbers of repetition. For example, a single repetition was shown for inverse fast Fourier transform (IFFT) 32768 and for MUSIC and three repetitions were shown for IFFT 32768 and for MUSIC. Increasing the number of repetitions increased the accuracy. That is, when an adaptive configuration 226 process was used with an increased number of HELTF repetitions, the accuracy of the ranging also increased. For example, comparing HELTF Rep 1 MUSIC to HELTF Rep 3 MUSIC showed that the normalized ratio of data packets having a ranging error of less than 2 meters was 0.7 for HELTF Rep 3 MUSIC but was about 0.63 for HELTF Rep 1 MUSIC. Furthermore, comparing HELTF Rep 1 IFFT 32768 to HELTF Rep 3 IFFT 32768 showed that the normalized ratio of data packets having a ranging error of less than 4 meters was 0.8 for HELTF Rep 3 IFFT 32768 but was about 0.76 for HELTF Rep 1 IFFT 32768.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A responding station (STA) for adaptive ranging, comprising:
a transceiver configured to receive, from an initiating STA, a signal comprising one or more of a frame or a data packet; and
a processing device configured to:
identify, at the responding STA, one or more of the frame or the data packet;
identify, at the responding STA, one or more physical layer measurements based on the one or more of the frame or the data packet;
identify, at the responding STA, one or more application layer requests comprising a ranging accuracy level; and
determine, at the responding STA, one or more ranging parameters for a ranging operation based on the one or more physical layer measurements and the ranging accuracy level.

2. The responding station of claim 1, wherein the processing device is further configured to:
determine, at the responding STA, the one or more ranging parameters based on network resource usage.

3. The responding station of claim 1, wherein the processing device is further configured to:
compute adjusted ranging parameters using additional physical layer measurements received in one or more iterations using a feedback loop.

4. The responding station of claim 1, wherein the processing device is further configured to:
determine when a modification has occurred;
update the one or more ranging parameters when the modification has occurred; and
terminate the ranging operation when the modification has not occurred.

5. The responding station of claim 1, wherein the ranging operation is one or more of: a one-to-one ranging operation, a one-to-many ranging operation, or a many-to-many ranging operation.

6. The responding station of claim 1, wherein the ranging operation is one or more of trigger based or non-trigger based.

7. The responding station of claim 1, wherein the ranging parameters comprise one or more of: a number of bursts, a burst duration, a minimum change in fine time measurement (FTM), a priority level, a number of FTM frames per burst, a burst period, a format, a bandwidth, a number of repetitions, a number of spatial streams, a transmission power, a null data packet transmission power, a null data packet received signal strength indication (RSSI) target, an uplink (UL) RS SI target, an immediate feedback activity, a minimum measurement time, a maximum measurement time, or an availability window.

8. The responding station of claim 1, wherein the one or more physical layer measurements comprise one or more of: channel state information (CSI), a received signal strength indication (RSSI), an error vector magnitude (EVM), a first path, a mean channel delay, a tap estimate, a delay estimate, a power delay profile (PDP), or a Doppler estimate.

9. An initiating station (STA) for adaptive ranging, comprising:
a processing device configured to:
identify, at the initiating STA, one or more of a frame or a data packet based on one or more initial ranging parameters for a ranging operation;
compute, at the initiating STA, one or more physical layer measurements based on the one or more of the frame or the data packet;
identify, at the initiating STA, one or more application layer requests comprising a ranging accuracy level; and
compute, at the initiating STA, one or more adjusted ranging parameters for the ranging operation based on the one or more physical layer measurements and the ranging accuracy level; and
a transceiver configured to:
transmit, from the initiating STA to responding STA, the one or more of the frame or the data packet based on the one or more adjusted ranging parameters.

10. The initiating station of claim 9, wherein the processing device is further configured to:
determine, at the initiating STA, the one or more adjusted ranging parameters based on network resource usage.

11. The initiating station of claim 9, wherein the processing device is further configured to:
compute additional adjusted ranging parameters using additional physical layer measurements received in one or more iterations using a feedback loop.

12. The initiating station of claim 9, wherein the processing device is further configured to:
determine when a modification has occurred;
update the one or more adjusted ranging parameters when the modification has occurred; and
terminate the ranging operation when the modification has not occurred.

13. The initiating station of claim 9, wherein one or more of the initial ranging parameters of the adjusted ranging parameters comprise one or more of: a number of bursts, a burst duration, a minimum change in fine time measurement (FTM), a priority level, a number of FTM frames per burst, a burst period, a format, a bandwidth, a number of repetitions, a number of spatial streams, a transmission power, a null data packet transmission power, a null data packet received signal strength indication (RSSI) target, an uplink (UL) RSSI target, an immediate feedback activity, a minimum measurement time, a maximum measurement time, or an availability window.

14. The initiating station of claim 9, wherein the one or more physical layer measurements comprise one or more of: channel state information (CSI), a received signal strength indication (RSSI), an error vector magnitude (EVM), a first path, a mean channel delay, a tap estimate, a delay estimate, a power delay profile (PDP), or a Doppler estimate.

15. A method for adaptive ranging, comprising:
receiving a ranging accuracy level from an application layer of a first station (STA) in wireless communication with a second STA;
receiving one or more physical layer measurements of the first STA; and
computing one or more ranging parameters for a ranging operation based on the ranging accuracy level and the one or more physical layer measurements.

16. The method of claim 15, further comprising:
receiving one or more of a frame or a data packet from an application layer of the first STA.

17. The method of claim 15, further comprising:
determining the one or more adjusted ranging parameters based on network resource usage.

18. The method of claim 15, further comprising:
computing adjusted ranging parameters using additional physical layer measurements received in one or more iterations using a feedback loop.

19. The method of claim 15, further comprising:
determining when a modification has occurred;
updating the one or more ranging parameters when the modification has occurred; and
terminating the ranging operation when the modification has not occurred.

20. The method of claim 15, wherein:
the one or more ranging parameters comprise one or more of: a number of bursts, a burst duration, a minimum change in fine time measurement (FTM), a priority level, a number of FTM frames per burst, a burst period, a format, a bandwidth, a number of repetitions, a number of spatial streams, a transmission power, a null data packet transmission power, a null data packet received signal strength indication (RSSI) target, an uplink (UL) RSSI target, an immediate feedback activity, a minimum measurement time, a maximum measurement time, or an availability window; or
the one or more physical layer measurements comprise one or more of: channel state information (CSI), a received signal strength indication (RSSI), an error vector magnitude (EVM), a first path, a mean channel delay, a tap estimate, a delay estimate, a power delay profile (PDP), or a Doppler estimate; or
a combination thereof.
